(19) United States
(12) Patent Application Publication
(10) Pub. No.: US 2025/0093941 A1
(43) Pub. Date: Mar. 20, 2025

(54) PERFORMANCE-AWARE SMART FRAMEWORK TO IMPROVE CPU POWER EFFICIENCY IN STATIC DISPLAY READ MODE

(71) Applicant: QUALCOMM INCORPORATED, SAN DIEGO, CA (US)

(72) Inventors: Karthik RANGARAJU, San Diego, CA (US); Wangling ZHANG, Shanghai (CN)

(21) Appl. No.: 18/841,343

(22) PCT Filed: Apr. 24, 2022
(86) PCT No.: PCT/CN2022/088708

§ 371 Date: Aug. 23, 2024

(51) Int. Cl. G06F 1/3293; G06F 1/329

(52) U.S. Cl. CPC G06F 1/3293; G06F 1/329

(57) ABSTRACT

Systems, methods and computer-readable mediums may reduce CPU power costs in a portable computing device (PCD). When logic of the PCD determines that the PCD enters a static display read mode while running an App or an Internet web browser, it determines (1) if display key performance indicator (KPI) headroom of the PCD indicates that cost-saving actions can be performed without degrading visual performance and (2) if there is an active display buffer submission. If the answer to (1) is yes and (2) is no, the logic analyzes hysteresis statistics associated with the CPU entering and exiting low power mode (LPM) to calculate a total number of CPU LPM entries and exits during a preselected time window. The total number is compared to a preselected threshold (TH) value and one or more power cost-saving actions are performed if the total number exceeds the preselected TH value.

### DESCRIPTION OF THE RELATED ART

Portable computing devices (PCDs), which generally include mobile phones, tablet portable computers (i.e., iPads), and laptops, all run on batteries when not being charged. Various reader application programs (reader Apps), reader application package kits (APKs), and Internet web browsers installed on PCDs are often used by PCD users to read content (i.e., a novel, a newspapers, a document, etc.). PCDs come in a variety of platforms and the manners in which they perform power management schemes vary depending on the particular platform of the PCD and on the particular reader App or Internet web browser that is being used at a given time by the user to read content.

These reader Apps, APKs and Internet web browsers operating in reader mode often consume significant amounts of battery power for the PCD. It has been observed that reader App-specific threads/processes can cause the central processing unit (CPU) processing core clusters (CPU&Cluster) to enter and exit the low power mode (LPM) states a large number of times per frame, even when the reader App, APK or Internet web browser is in static display read mode. CPU&Cluster entry into and exit from the LPM state a large number of times per frame results in a large amount of power loss.

Some reader Apps or APKs are configured to trigger a Power Management Quality of Service (PMQOS) process that prevents the CPU&Cluster LPM entry/exit when the reader App detects a buffer submission. However, since there are no buffer submissions when the reader App is in static display read mode, the PMQOS process is not triggered when the reader App or APK is in statis display read mode. A buffer submission, as that term is used in the present disclosure, refers to a sequence of activity from (App/Ui->command buffer->graphical or compute unit or AI unit->N-dimensional rendered outcomes->display buffer/framebuffer->display). When the actual content changes, this is observed on the display. The UI/Application needs to submit “command buffers” to the graphics engine (e.g., GPU, CDSP, etc.) to render the content to generate the required N-dimensional output or graphic content requested by the submitter (e.g., UI/Application), which, in turn, is finally delivered to the display buffer/frame buffer for final content display. This final change in display or frame buffer is referred to as “buffer submission” in this context.

Some other reasons that reader Apps and Internet web browsers inefficiently consume power in static display read mode are: (1) housekeeping and wakeup tasks are spread across all of the cores available in CPU, resulting in utilization of all of the CPU cores even though there is no resulting gain in performance; and/or (2) housekeeping or wakeup tasks are not well organized or grouped to use system resources of the CPU. The traditional kernel scheduler/framework in PCDs is not capable of handling APK-specific patterns of wakeups or housekeeping behavior generated from an APK. The traditional Kernel scheduler/framework in Android/Apple operating systems (iOSs) does not have visibility into APK/APP behavior in user space along with the operating system (OS)-specific workload.

Therefore, these reader Apps, APKs and Internet web browsers in reader mode do not provide the PMQOS needed in PCDs when operating in static display read mode, which results in inefficient power usage in PCDs. A need exists for systems and methods for improving CPU power efficiency in PCDs when the PCDs are running an App or an Internet web browser operating in reader mode when the PCD is operating in static display read mode.

### SUMMARY OF THE DISCLOSURE

Systems, methods, computer-readable media, and other examples are disclosed herein for improving CPU power efficiency in PCDs when the PCDs are running an App or Internet web browser operating in static display read mode.

An exemplary system for reducing central processing unit (CPU) power costs in a PCD may comprise logic disposed on an integrated circuit (IC) chip of the PCD. The logic may be configured to determine if the PCD enters a static display read mode while running a mobile device App or Internet web browser operating in reader mode, and if so, to determine if a display key performance indicator (KPI) headroom of the PCD indicates that one or more cost-saving actions can be performed without degrading visual performance of a display of the PCD and to determine if there is an active display buffer submission. If it is determined that display KPI headroom indicates that one or more cost-saving actions can be performed without degrading visual performance and that there is no active display buffer submission, then the logic analyzes hysteresis statistics associated with the CPU entering and exiting LPM to calculate a total number of LPM entries and exits during a preselected time window. The logic compares the total number to a first preselected threshold (TH) value and performs one or more power cost-saving actions if the total number exceeds the first preselected TH value.

An exemplary embodiment of the method for reducing CPU power costs in a PCD may comprise, in a logic disposed on an integrated circuit (IC) chip of the PCD:
determining if the PCD enters a static display read mode while running a mobile device software application program (App) or Internet web browser operating in reader mode, and if so:
   determining (1) if a display key performance indicator (KPI) headroom of the PCD indicates that one or more cost-saving actions can be performed without degrading visual performance of a display of the PCD and (2) if there is an active display buffer submission;
   if it is determined that display KPI headroom indicates that one or more cost-saving actions can be performed without degrading visual performance and that there is no active display buffer submission:
      analyzing hysteresis statistics associated with the CPU entering a low power mode (LPM) and exiting the LPM to calculate a total number of LPM entries and exits equal to a number of times the CPU enters the LPM during a preselected time window plus a number of times that CPU exits the LPM during the time window; and
      comparing the total number to a first preselected TH value and performing one or more power cost-saving actions if the total number exceeds the first preselected TH value.

An exemplary embodiment of a non-transitory computer-readable medium comprises computer instructions for execution by logic disposed on an IC chip of a PCD for reducing CPU power costs in the PCD. The computer instructions may comprise a first set of instructions that determines if the PCD enters a static display read mode while running a mobile device App or Internet web browser operating in reader mode, and if so, further comprises a second set of instructions that determines (1) if a display KPI headroom of the PCD indicates that one or more cost-saving actions can be performed without degrading visual performance of a display of the PCD and (2) if there is an active display buffer submission. If it is determined with the second set of instructions that display KPI headroom indicates that one or more cost-saving actions can be performed without degrading visual performance and that there is no active display buffer submission, the computer instructions may further comprise a third set of instructions that analyze hysteresis statistics associated with the CPU entering and exiting LPM to calculate a total number of LPM entries and exits during a preselected time window. The computer instructions may further comprise a fourth set of instructions that compares the total number to a first TH value and performs one or more power cost-saving actions if the total number exceeds the first preselected TH value.

These and other features and advantages will become apparent from the following description, drawings and claims.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a graph having a vertical axis showing the number of times a CPU or CPU core cluster of a PCD running a particular reader App enters and exists the LPM state over a window of time shown on the horizontal axis.

FIG. 2 is a table showing some operating and performance statistics per frame for a few reader APKs operating in static display read mode and the power cost for each APK due to inefficient utilization of CPU cores and due to large numbers of LPM entries and exits.

FIG. 3 illustrates an example of a PCD, such as a mobile phone or smartphone, in which exemplary embodiments of systems, methods, computer-readable media, and other examples of providing the performance-aware smart framework for reducing power costs may be provided.

FIG. 4 is a flow diagram of the performance-aware smart framework algorithm in accordance with a representative embodiment.

FIGS. 5A and 5B together form a flow diagram that represents the performance-aware smart framework method for reducing power cost in accordance with an exemplary embodiment.

### DETAILED DESCRIPTION

The present disclosure discloses systems, methods and computer-readable mediums for reducing CPU power costs in a PCD by determining when the PCD enters a static display read mode while running an App or an Internet web browser operating in reader mode. While the PCD remains in static display read mode, logic of the PCD determines (1) if a display key performance indicator (KPI) headroom of the PCD indicates that one or more cost-saving actions can be performed without degrading visual performance of a display of the PCD and (2) if there is an active display buffer submission. If the answers to (1) and (2) are yes and no, respectively, hysteresis statistics associated with the CPU entering and exiting LPM are analyzed to calculate a total number of CPU LPM entries and exits during a preselected time window. The total number is compared to a first preselected threshold (TH) value and one or more power cost-saving actions are performed if the total number exceeds the first preselected TH value.

In the following detailed description, for purposes of explanation and not limitation, exemplary, or representative, embodiments disclosing specific details are set forth in order to provide a thorough understanding of an embodiment according to the present teachings. The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects. However, it will be apparent to one having ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or more memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

A computing device may include multiple subsystems, cores or other components. Such a computing device may be, for example, a portable computing device (“PCD”), such as a laptop or palmtop computer, a cellular telephone or smartphone, portable digital assistant, portable game console (e.g., an Extended Reality (XR) device, a Virtual Reality (VR) device, an Augmented Reality (AR) device, or a Mixed Reality (MR) device), etc.

An “App”, as that term is used throughout the remainder of this disclosure, refers to a software application program that is designed to run on a PCD, including, but not limited to, Apps that are designed to run on Windows, iOS and Android mobile platforms as well as APKs that are designed to run only on Android platforms.

The multiple subsystems, cores or other components of a computing device may be included within the same integrated circuit chip or in different chips. A “system-on-a-chip” or “SoC” is an example of one such chip that integrates numerous components to provide system-level functionality. For example, an SoC may include one or more types of processors, such as central processing units (“CPU”s), graphics processing units (“GPU”s), digital signal processors (“DSP”s), and neural processing units (“NPU”s). An SoC may include other processing subsystems, such as a transceiver or “modem” subsystem that provides wireless connectivity.

A computing device may include resources that are shared among SoC processors or other processing subsystems. For example, processors may share access to a main or system memory of the computing device. A processor may also be associated with a local cache memory.

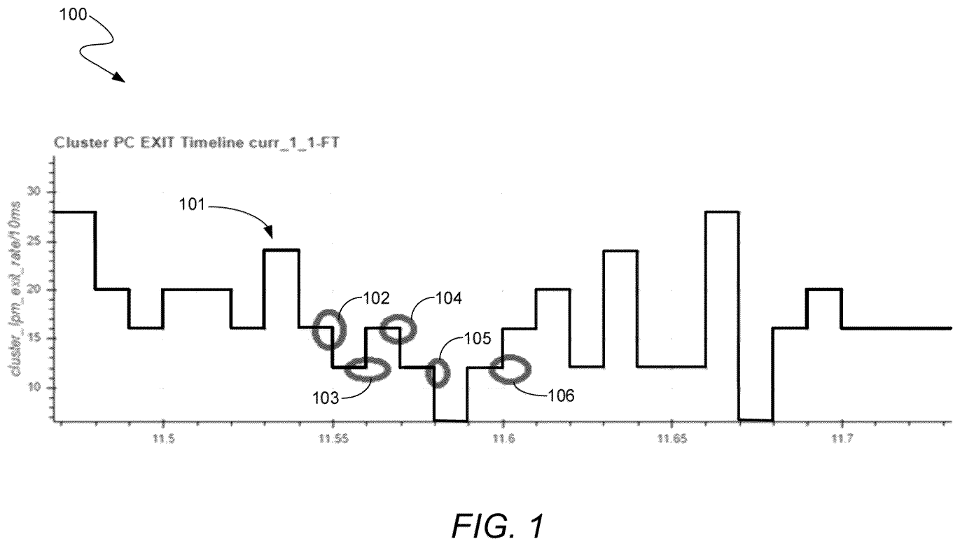

FIG. 1 is a graph 100 having a vertical axis showing the number of times a CPU or CPU core cluster of a PCD running a particular reader App enters and exists the LPM state over a window of time shown on the horizontal axis. In FIG. 1, any change in direction of the plot 101 corresponds to LPM state entry or exit. For example, the locations on plot 101 that are encircled with circles 102-106 correspond LPM state entries or exits. This graph shows that given single frame duration, such as, for example, 120 frames per second (fps)=8 milliseconds (ms), there is a very large number of changes in the LPM pattern. For this particular reader App of this example, there are about thirty-two direction changes in plot 101 during this time window corresponding to about thirty-two LPM state entries or exists, which results in a relatively large amount of power loss. Similar results can be obtained for other commonly used reader Apps, APKs and Internet web browsers running on PCDs.

The following is true for causes where an App or Internet web browser is operating in statis display read mode:
1. The traditional kernel scheduler/framework is not capable of handling App specific wakeups patterns or housekeeping behavior;
2. The traditional Kernel scheduler/framework in Android/iOS platforms does not have visibility of App behavior in user space along with the OS-specific workload, which is expected as there is motivation to keep the scheduler framework light wight, but at a cost in terms of power consumption; and
3. App-specific system state (e.g., Performance state) is not known to Kernel scheduler/framework.

In current state-of-the-art PCDs, during static display read mode operations of reader Apps and Internet web browsers in read mode, CPU power costs are higher if (1) housekeeping tasks and wakeups are spread across all the cores available in the CPU, resulting in utilization all CPU cores even though no performance gain is achieved, (2) housekeeping tasks or wakeups are not well organized or grouped to most efficiently use the system resources of the CPU, and (3) there is abnormal or random core behavior (e.g., CPU core behavior), such as unnecessary entries/exits from the LPM mode state, which is key for any SOC in Power domain.

For all of these reasons, there is a detrimental impact on power usage in static display read mode scenarios for Apps and Internet web browsers operating in read mode. The performance-aware smart framework algorithm and logic of the present disclosure provides a solution to this problem. It should be noted that while representative, or exemplary, embodiments are described herein with reference to reader Apps, the inventive principles and concepts are applicable to, and can be beneficially used with, any App that can sometimes enter static display read mode and any Internet web browser that operates in read mode and that can sometimes enter static display read mode.

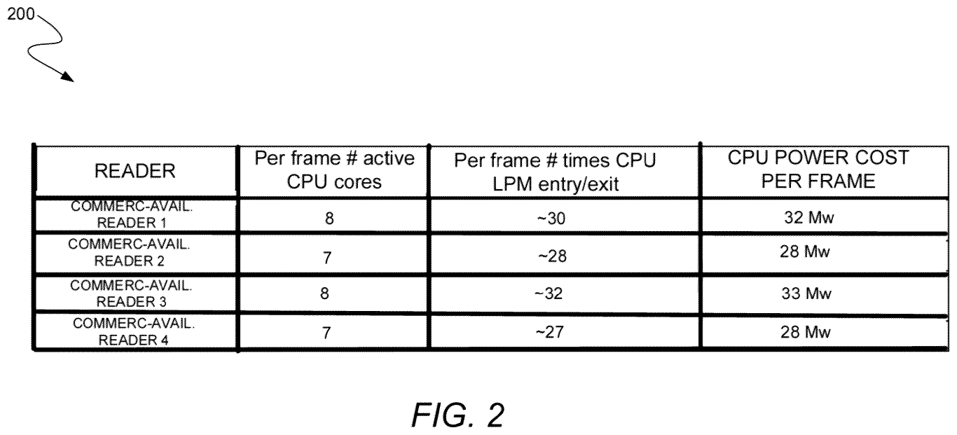

FIG. 2 is a table 200 showing some operating and performance statistics per frame for a four different commercially-available reader APKs operating in static display read mode. The first commercially-available APK reader, Reader 1 in table 200, utilizes eight CPU cores, enters/exits LPM state mode about thirty times and costs 32 milli-Watts (mW) of CPU power per frame. The second commercially-available reader APK, Reader 2 in table 200, utilizes seven CPU cores, enters/exits LPM state about twenty-eight times and costs 28 mW of CPU power per frame. The third commercially-available reader APK, Reader 3 in table 200, utilizes eight CPU cores, enters/exits LPM state about thirty-two times and costs 32 mW of CPU power per frame. The fourth commercially-available reader APK, Reader 4 in table 200, utilizes seven CPU cores, enters/exits LPM state about twenty-seven times and costs 28 mW of CPU power per frame.

Thus, it can be seen from the above description of FIGS. 1 and 2 that a power management scheme is needed for static display read mode scenarios to provide more efficient CPU core utilization and to reduce the number of LPM state entries/exists that occur, thereby reducing CPU power costs.

In accordance with a representative embodiment of the present disclosure, a performance-aware smart framework algorithm is launched, or triggered, when the PCD enters a static display read mode while running an App or when a whitelisted App is launched. The term “whitelisted” in the context of the present disclosure means that the App has been designated by an original equipment manufacturer (OEM) or user of the PCD as an App that can (1) benefit from running the performance-aware smart framework algorithm, either at all times that the App is running or during times of certain use case scenarios of the App, and that (2) taking the power cost-saving actions that are taken by the performance-aware smart framework algorithm (discussed below) during these times will not degrade visual performance. This “whitelisted” designation is saved somewhere in memory of the PCD that is accessible by a processor of the PCD that can trigger the performance-aware smart framework algorithm and cause it to jump directly to taking one or more power cost-saving actions if there are no active buffer submissions.

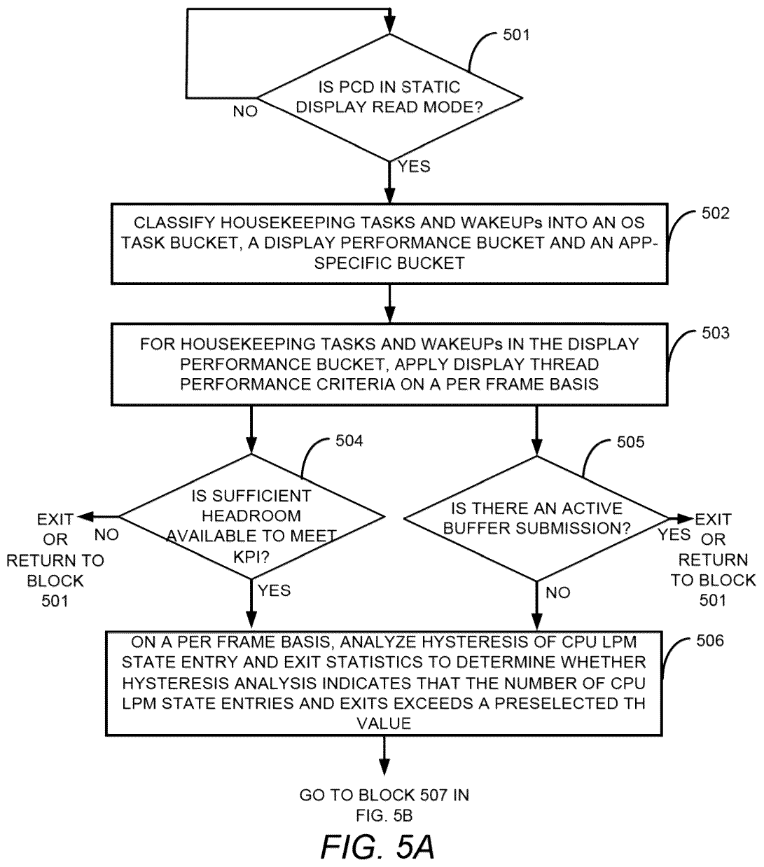

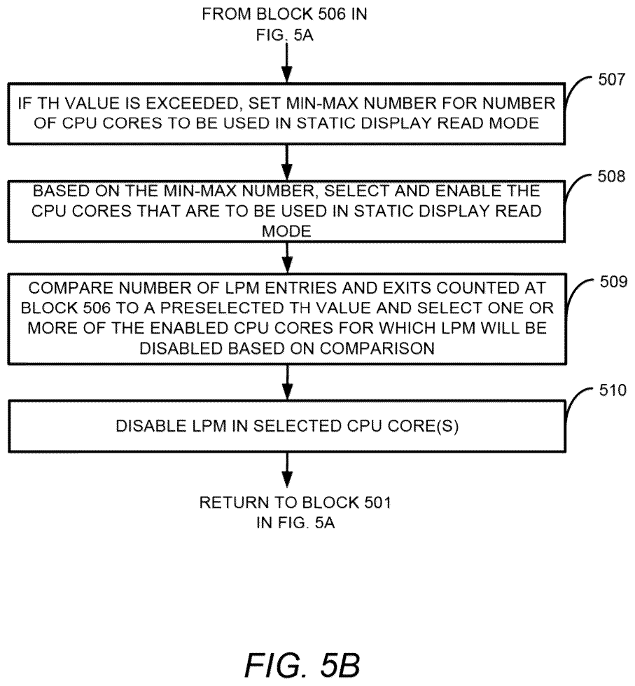

When the performance-aware smart framework algorithm is launched, or triggered, it determines if (1) there is sufficient display key performance index (KPI) headroom to perform one or more power cost-savings acts and (2) if there are any current display buffer submissions. If queries (1) and (2) are answered yes and no, respectively, then the algorithm analyzes the hysteresis of the LPM state entries/exists statistics (i.e., the data that is used for a plot of the type shown in FIG. 1) over a window of time (e.g., per frame) and decides whether or not to perform one or more power cost-saving actions based on the hysteresis analysis. A variety of power cost-saving actions can be performed, a few examples of which are described below with reference to FIGS. 5A and 5B.

As indicated above, if the App is whitelisted, this is an indication that a determination has previously been made that the answer to (1) is yes. In this case, the determination of (1) can be equated to determining that the App is whitelisted, which was determined at launch of the App. This allows the performance-aware smart framework algorithm to jump to the determination of (2) immediately up the algorithm being triggered. In this case, if the answer to the determination made at (2) is no, then the algorithm analyzes the hysteresis of the LPM state entries/exists statistics over a window of time (e.g., per frame) and decides whether or not to perform one or more power cost-saving actions based on the hysteresis analysis.

In accordance with a representative embodiment, the hysteresis of the CPU LPM entries/exits is used by counting the number of CPU LPM entries and exits that occurred in the most recent frame, comparing that number to a preselected threshold (TH) value, and if that number exceeds the preselected TH value, performing at least one of the following cost-saving actions: (1) limiting the number of CPU cores that can be utilized while operating in static display read mode; (2) of the limited number of CPU cores that can be utilized, selecting one or more of the CPU cores for utilization; and (3) limiting the number of LPM state entries/exits that can occur in at least one of the CPU cores that have been selected for utilization, e.g., by disabling the LPM mode for one or more of the cores being utilized.

As will be described below in more detail with reference to FIGS. 5A and 5B, performing one or more of these power cost-saving actions when the PCD is in static display read mode results in significantly improved CPU power utilization. As will be discussed below in more detail, one or more additional power cost-saving actions can also be performed to further reduce CPU power cost during static display read mode.

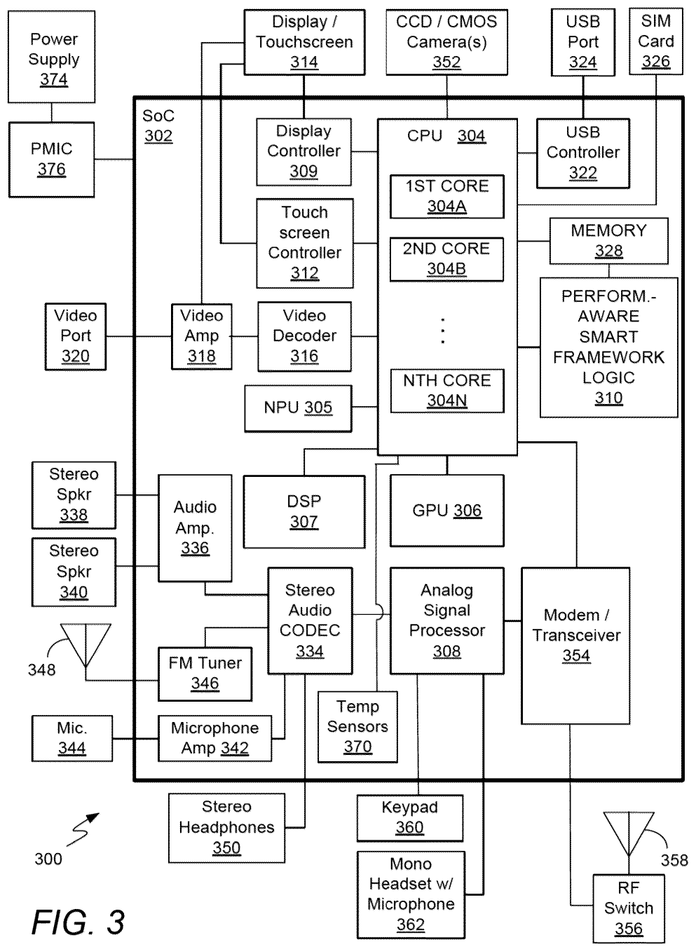

The systems and methods of the present disclosure for providing the performance-aware smart framework for reducing power costs can be implemented in a PCD, although the inventive principles and concepts are not limited with respect to the type of device in which the method is implemented. FIG. 3 illustrates an example of a PCD 300, such as a mobile phone, a smartphone, or a portable game console such as an Extended Reality (XR) device, a Virtual Reality (VR) device, an Augmented Reality (AR) device, or a Mixed Reality (MR) device, in which exemplary embodiments of systems, methods, computer-readable media, and other examples of providing the performance-aware smart framework for reducing power costs may be implemented. For purposes of clarity, some interconnects, signals, etc., are not shown in FIG. 3. Although the PCD 300 is shown as an example, other embodiments of systems, methods, computer-readable media, and other examples of using the performance-aware smart framework for reducing power costs may be provided in other types of computing devices or systems.

The PCD 300 may include an SoC 302. The SoC 302 may include a CPU 304, an NPU 305, a GPU 306, a DSP 307, an analog signal processor 308, a modem/modem subsystem 354, or other processors. The CPU 304 may include one or more CPU cores, such as a first CPU core 304A, a second CPU core 304B, etc., through an Nth CPU core 304N, where N is a positive integer that is greater than or equal to one.

The cores 304A-304N may be configured to perform certain operations in accordance with the performance-aware smart framework of the present disclosure. In accordance with a representative embodiment, the SoC 302 includes performance-aware smart framework logic 310 that communicates with the CPU 304 to perform the performance-aware smart framework algorithm. The CPU cores 304A-304N perform other operations of the type that they normally perform in a PCD. Alternatively, or in addition, any of the processors, such as the NPU 305, GPU 306, DSP 307, etc., may perform some or all of those operations. It is also possible to implement the performance-aware smart framework logic 310 within the CPU 304 instead of in a separate logic block.

A display controller 309 and a touch-screen controller 312 may be coupled to the CPU 304. A touchscreen display 314 external to the SoC 302 may be coupled to the display controller 310 and the touch-screen controller 312. The PCD 300 may further include a video decoder 316 coupled to the CPU 304. A video amplifier 318 may be coupled to the video decoder 316 and the touchscreen display 314. A video port 320 may be coupled to the video amplifier 318. A universal serial bus (“USB”) controller 322 may also be coupled to CPU 304, and a USB port 324 may be coupled to the USB controller 322. A subscriber identity module (“SIM”) card 326 may also be coupled to the CPU 304.

One or more memories 328 may be coupled to the CPU 304. The one or more memories 304 may include both volatile and non-volatile memories. Examples of volatile memories include static random access memory (“SRAM”) and dynamic random access memory (“DRAM”). Such memories may be external to the SoC 302 or internal to the SoC 302. The one or memories 328 may include local cache memory or a system-level cache memory.

A stereo audio CODEC 334 may be coupled to the analog signal processor 308. Further, an audio amplifier 336 may be coupled to the stereo audio CODEC 334. First and second stereo speakers 338 and 340, respectively, may be coupled to the audio amplifier 336. In addition, a microphone amplifier 342 may be coupled to the stereo audio CODEC 334, and a microphone 344 may be coupled to the microphone amplifier 342. A frequency modulation (“FM”) radio tuner 346 may be coupled to the stereo audio CODEC 334. An FM antenna 348 may be coupled to the FM radio tuner 346. Further, stereo headphones 350 may be coupled to the stereo audio CODEC 334. Other devices that may be coupled to the CPU 304 include one or more digital (e.g., CCD or CMOS) cameras 352.

A modem or RF transceiver 354 may be coupled to the analog signal processor 308 and the CPU 304. An RF switch 356 may be coupled to the RF transceiver 354 and an RF antenna 358. In addition, a keypad 360, a mono headset with a microphone 362, and a vibrator device 364 may be coupled to the analog signal processor 308. The SoC 302 may have one or more internal or on-chip thermal sensors 370. A power supply 374 and a PMIC 376 may supply power to the SoC 302.

Firmware or software may be stored in any of the above-described memories, or may be stored in a local memory directly accessible by the processor hardware on which the software or firmware executes. Execution of such firmware or software may control aspects of any of the above-described methods or configure aspects any of the above-described systems. Any such memory or other non-transitory storage medium having firmware or software stored therein in computer-readable form for execution by processor hardware may be an example of a “computer-readable medium,” as the term is understood in the patent lexicon.

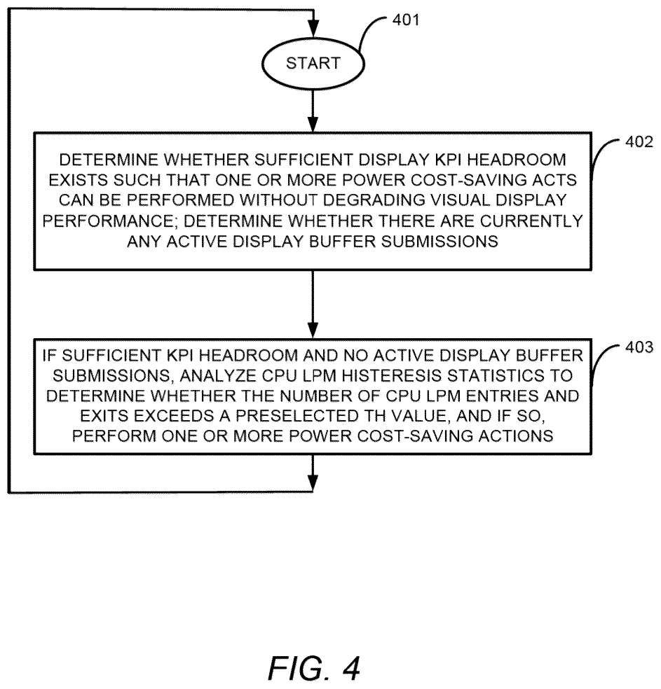

FIG. 4 is a flow diagram of the performance-aware smart framework algorithm in accordance with a representative embodiment. In accordance with a representative embodiment of the present disclosure, the performance-aware smart framework algorithm is triggered, or launched, at block 401 when the PCD enters a static display read mode, or at launch of a whitelisted App. In the step represented by block 402, while the PCD remains in static display ready mode, the performance-aware smart framework logic 310 (FIG. 3) answers the following inquiries: (1) is sufficient display KPI headroom available for the logic 310 to perform one or more costs-saving actions of the present disclosure without causing one or more display KPIs to drop to an unacceptable level that indicates a degradation of visual performance? (2) is there currently an active display buffer submission? As indicated above, inquiry (1) can be equated to the previous determination at launch that the App is whitelisted.

At block 403, if inquiries (1) and (2) of block 402 are answered yes and no, respectively, the logic 310 analyzes the CPU LPM entry/exit hysteresis statistics to determine whether the number of CPU LPM entries and exits exceeds a preselected TH value, and if so, causes one or more power cost-saving actions to be performed, as will be described below in detail with reference to FIGS. 5A and 5B.

If the PCD exits the static display read mode at any time during the processes represented by blocks 401-403, the algorithm performed by logic 310 resets and returns to block 401 to continue monitoring for entry of the PCD into the static display read mode. The process depicted in FIG. 4 can be performed on a per-frame basis or once for every preselected number of frames.

As indicated above, a variety of power cost-saving actions can be performed, as will be described below with reference to FIGS. 5A and 5B. Generally, the cost-saving actions include one or more of: (1) limiting the number of CPU cores that can be utilized while operating in static display read mode; and (2) limiting the number of LPM state entries/exits that can occur in at least one of the CPU cores that have been selected for utilization, e.g., by disabling the LPM mode for one or more of the cores being utilized. Other actions discussed below with reference to FIGS. 5A and 5B can also be performed, as will be discussed below in more detail.

FIG. 5A is a flow diagram that represents the performance-aware smart framework method performed by logic 310 (FIG. 3) for reducing power cost in accordance with an exemplary embodiment. At the step represented by block 501, a determination is made as to whether the PCD is in static display read mode. This can be identical to the step represented by block 402 in FIG. 4, although other methods can be used to determine when the PCD is in static display read mode. If so, the process proceeds to block 502 at which App housekeeping tasks and wakeups are classified into three buckets, namely, (1) a system-specific/OS-specific task bucket, (2) a display performance bucket and (3) an App-specific bucket. App or APK wakeups or housekeeping tasks fall mainly into these three buckets.

Bucket (1) corresponds to OS/System-specific tasks or App/APK wakeups/housekeeping tasks. These are system-specific housekeeping tasks or wakeups that are generic in nature, e.g., specific to Android or iOS platforms or to the OS of the PCD. Bucket (2) corresponds to display performance tasks or wakeups/housekeeping task. More specifically, these are performance tasks related to the display thread that is responsible for affecting fps/jank or otherwise impacting the visible performance of the display. Bucket (3) corresponds to APK-specific tasks or wakeups/housekeeping tasks. These tasks relate to additional framework-specific housekeeping tasks or wakeups associated with App/APK and system tasks that are performed when more than one App or APK is running on the PCD.

Classifying these tasks and wakeups into these three buckets is fairly straight forward and well understood by those of skill in the art, but the classification process will be briefly described. For bucket (2), these tasks and wakeups can be identified for a given OS and whitelisted. For bucket (3), when an App or APK is launched, their sibling associated process ID (PID) can be extracted and maintained in a list. For bucket (1), these tasks and wakeups generally correspond to all of the remaining tasks/threads that not belong in buckets (1) or (2), i.e., they belong to OS.

At the step represented by block 503, for the housekeeping tasks and wakeups that have been classified into bucket (2), display threads are monitored on a per-frame basis for key performance indicators (KPIs). At block 504, a determination is made as to whether the analysis made at block 503 indicates that there is sufficient headroom to perform power cost-saving actions without degrading visual display performance, such as by determining whether the analysis indicates that no fps drop/janks or similar issues are occurring that detrimentally impact visually-perceptible performance. The manner in which the amount of headroom can be determined and analyzed to determine whether KPIs are being met is understood by those of skill in the art. An example of one way for tapping headroom in an Android PCD is with the following command: SF en-deq w.r.t Vsync boundary for given panel.

Simultaneously with the process being performed at block 504, a determination is made at block 505 as to whether the analysis performed at block 503 indicates that there is an active buffer submission. If blocks 504 and 505 are answered “yes” and “no”, respectively, this is an indication that (1) display performance KPI(s) indicate that display performance is of sufficiently quality that performing one or more power cost-saving actions will not detrimentally impact visual performance, and (2) that the PCD is still in static display read mode, respectively. If blocks 504 and 505 are answered “no” and “yes”, respectively, this is an indication that (1) performing one or more power cost-saving actions may detrimentally impact visual performance, and (2) that the PCD is no longer in static display read mode, respectively. In the latter case, the performance-aware smart framework algorithm can exit or return to block 501, at which point the performance-aware smart framework logic 310 (FIG. 3) continues to monitor the PCD to determine when it re-enters static display read mode.

If blocks 504 and 505 are answered “yes” and “no”, respectively, then the process proceeds to block 506. At block 506, the hysteresis of the CPU LPM entry and exit statistics are analyzed on a per-frame basis to determine whether the number of CPU LPM entries and exists exceeds a preselected TH value. As indicated above with reference to block 403 of FIG. 4, if the number of CPU LPM entries and exits exceeds the preselected TH value, one or more power-cost-saving actions are performed, as will be described below with reference to blocks 507-510 of FIG. 5B.

It should be noted that on the first run of the performance-aware smart framework algorithm represented by FIGS. 5A and 5B, the determination represented by block 504 can be equated to the determination that is made at launch of an App that has previously been designated as a whitelisted App. In this case, the step represented by block 504 can be skipped on the first run of the performance-aware smart framework algorithm for a whitelisted App.

Examples of particular power cost-saving actions that can be taken are represented by the flow diagram shown in FIG. 5B. FIG. 5B is a flow diagram of a CPU core power optimization algorithm that is performed in accordance with an exemplary embodiment to carry out the power cost-saving actions if the number of CPU LPM entries and exits exceeds the preselected TH value, assuming there is sufficient KPI headroom and there are no active display buffer submissions.

At the step represented by block 507 in FIG. 5B, if the number of CPU LPM entries and exits exceeds the preselected TH value, a minimum number and a maximum number of CPU cores to be used while the PCD is in the static display read mode is set. These minimum and maximum numbers are referred to hereinafter as the MIN-MAX number pair, since it is made up of a pair of numbers. This MIN-MAX number pair can be generated beforehand by determining the minimum number of CPU cores that need to be active and the maximum number that may need to be active for an App or Internet web browser in read mode in order for them to operate without visually-perceptible performance degradation. It should be noted that this type of approach is not possible with a generic scheduler in a traditional PCD system because traditional schedulers do not understand the App's behavior and can be controlled by an App that spreads the task across all CPU cores without any intelligence. An example of the MIN-MAX number pair in accordance with the present disclosure is (2,3) which means that two cores are always enabled, and a third core can be enabled if any spike in workload is demanded from scheduler sleep state.

At the step represented by block 508, one or more CPU cores are selected and enabled according to the MIN-MAX number pair that is set at block 507. Once the MIN-MAX number pair has been set at block 507, the CPU cores can be selected at block 508 randomly or based on one or more other considerations or criteria. For example, CPU cores in the PCD system can be ranked from lower to higher in terms of their respective power costs, in which case the CPU cores having a lower ranking can be selected over CPU cores having a higher ranking. As another example, the CPU cores can be ranked from low to high in terms of the current workload, demand and/or utilization reported by the underlying scheduler/framework, in which case the CPU cores having a lower ranking can be selected over CPU cores having a higher ranking. A combination of these two cases is also possible, and other considerations or criteria can be taken into account in selecting and enabling the CPU cores.

The steps represented by blocks 507 and 508 are examples of power cost-saving actions that can be performed. An additional power cost-saving action that can be performed is to selectively disable the LPM in one or more of the CPU cores that were selected and enabled at block 508. At the step represented by block 509, the number of LPM entries and exits that are determined at block 506 of FIG. 5A is compared to a second TH value and the LPM of one or more of the selected cores are disabled to prevent those core(s) from entering and exiting LPM during static display read mode. The CPU core power cost per frame can be estimated for each CPU core based on the number of LPM entries/exits that result in a particular power penalty for each CPU core. This number can then be used as the second TH value at block 509 such that if the number counted at block 506 exceeds the second TH value, the LPM is disabled in the corresponding core(s). Block 510 represents the step of disabling the LPM state in one or more of the cores based on the process performed in block 509.

This second TH value can be based on a pre-estimate that is configured into the logic 310 in a factory setting, for example. It is also possible to perform the estimate and set the second TH value on the fly during operations of the PCD using internal logic of the PCD or using logic that is external to the PCD. The first and second TH values can be stored in memory of the PCD, such as in memory 328 (FIG. 3) or some other memory device that resides on or is accessible by the PCD 300.

It should be noted that additional CPU power cost-savings actions can be performed, such as selectively disabling LPM in cache memory used by the cores, dynamically ramping down CPU operating frequency for the actual workload, dynamically reducing bus bandwidth (BW), dynamically reducing BW voting for DDR and all types cache memory, dynamically disabling LPM states and ramping down operating frequencies for any IPs in the PCD, such as, for example, GPU, NSP, CDSP, ADSP, Modem, WLAN, sensors, and/or DPU, and/or dynamically increasing the number of CPU cores and/or the amount of cache that are enabled based on current workload and resource utilization.

Implementation examples are described in the following numbered clauses:
1. A system for reducing central processing unit (CPU) power costs in a portable computing device (PCD), the system comprising:
   logic disposed on an integrated circuit (IC) chip of the PCD, the logic being configured to:
   determine if the PCD enters a static display read mode while running a mobile device software application program (App) or Internet web browser operating in reader mode, and if so:
   determine (1) if a display key performance indicator (KPI) headroom of the PCD indicates that one or more cost-saving actions can be performed without degrading visual performance of a display of the PCD and (2) if there is an active display buffer submission;
   if it is determined that display KPI headroom indicates that one or more cost-saving actions can be performed without degrading visual performance and that there is no active display buffer submission:
   analyze hysteresis statistics associated with the CPU entering a low power mode (LPM) and exiting the LPM to calculate a total number of LPM entries and exits equal to a number of times the CPU enters the LPM during a preselected time window plus a number of times that CPU exits the LPM during the time window; and
   compare the total number to a first preselected threshold (TH) value and perform one or more power cost-saving actions if the total number exceeds the first preselected TH value.
2. The system of clause 1, wherein performing said one or more power cost-saving actions comprises at least one of:
   limiting a total number of cores of the CPU that are allowed to be utilized by the App or Internet web browser operating in reader mode to a limited number of CPU cores;
   of the limited number of CPU cores, enabling one or more of the CPU cores such that the enabled one or more CPU cores are available to utilized by the App or Internet web browser operating in reader mode; and
   limiting a total number of times at least one enabled CPU core is allowed to enter and exit LPM.
3. The system of clause 2, wherein the step of limiting the total number of times at least one enabled CPU core is allowed to enter and exit LPM is performed by disabling LPM in said at least one enabled CPU core.
4. The system of and of clauses 2 or 3, wherein the step of limiting the total number of cores of the CPU that are allowed to be utilized by the App or Internet web browser operating in reader mode is performed by:
   setting a minimum number of CPU cores that are needed by the App or Internet web browser to operate in static display read mode without degrading performance to a level that is visually perceivable by a user of the PCD; and
   setting a maximum number of CPU cores that may be needed by the App or Internet web browser to operate in static display read mode to ensure that performance will not degrade to a level that is visually perceivable by the user of the PCD.
5. The system of clauses 2-4, wherein the step of enabling one or more of the CPU cores is performed by:
   of the limited number of CPU cores, selecting the minimum number of CPU cores to be enabled based on one or more criteria; and
   enabling the selected minimum number of CPU cores.
6. The system of clause 5, wherein said one or more criteria include a ranking of each of the limited number of CPU cores in terms of power cost selecting the minimum number of CPU cores to be enabled based on the respective rankings.
7. The system of clause 5, wherein said one or more criteria include a ranking of each of the limited number of CPU cores in terms of at least one of current workload, current demand and current utilization reported by a scheduler of the App or Internet web browser.
8. The system of any of clauses 4-7, wherein the step of disabling LPM in said at least one enabled CPU core comprises:
   comparing the total number of LPM entries and exits to a second TH value;
   selecting one or more enabled CPU cores for which LPM will be disabled based on the comparison of the total number of LPM entries and exits to the second TH value; and
   disabling LPM in the selected one or more enabled CPU cores.
9. The system of clause 8, wherein the second TH value is set based on an estimation for each CPU core of a respective power penalty associated with LPM entries and exits of the respective CPU core.
10. A method for reducing central processing unit (CPU) power costs in a portable computing device (PCD), the method comprising, in logic disposed on an integrated circuit (IC) chip of the PCD:
   determining if the PCD enters a static display read mode while running a mobile device software application program (App) or Internet web browser operating in reader mode, and if so:
   determining (1) if a display key performance indicator (KPI) headroom of the PCD indicates that one or more cost-saving actions can be performed without degrading visual performance of a display of the PCD and (2) if there is an active display buffer submission;
   if it is determined that display KPI headroom indicates that one or more cost-saving actions can be performed without degrading visual performance and that there is no active display buffer submission:
   analyzing hysteresis statistics associated with the CPU entering a low power mode (LPM) and exiting the LPM to calculate a total number of LPM entries and exits equal to a number of times the CPU enters the LPM during a preselected time window plus a number of times that CPU exits the LPM during the time window; and
   comparing the total number to a first preselected threshold (TH) value and performing one or more power cost-saving actions if the total number exceeds the first preselected TH value.
11. The method of clause 10, wherein performing said one or more power cost-saving actions comprises at least one of:
   limiting a total number of cores of the CPU that are allowed to be utilized by the App or Internet web browser operating in reader mode to a limited number of CPU cores;
   of the limited number of CPU cores, enabling one or more of the CPU cores such that the enabled one or more CPU cores are available to utilized by the App or Internet web browser operating in reader mode; and
   limiting a total number of times at least one enabled CPU core is allowed to enter and exit LPM.
12. The method of clause 11, wherein the step of limiting the total number of times at least one enabled CPU core is allowed to enter and exit LPM comprises:
   disabling LPM in said at least one enabled CPU core.
13. The method of any of clauses 11 or 12, wherein the step of limiting the total number of cores of the CPU that are allowed to be utilized by the App or Internet web browser operating in reader mode comprises:
   setting a minimum number of CPU cores that are needed by the App or Internet web browser to operate in static display read mode without degrading performance to a level that is visually perceivable by a user of the PCD; and
   setting a maximum number of CPU cores that may be needed by the App or Internet web browser to operate in static display read mode to ensure that performance will not degrade to a level that is visually perceivable by the user of the PCD.
14. The method of any one of clauses 11-13, wherein the step of enabling one or more of the CPU cores comprises:
   of the limited number of CPU cores, selecting the minimum number of CPU cores to be enabled based on one or more criteria; and
   enabling the selected minimum number of CPU cores.
15. The method of clause 14, wherein said one or more criteria include a ranking of each of the limited number of CPU cores in terms of power cost selecting the minimum number of CPU cores to be enabled based on the respective rankings.
16. The method of clause 14, wherein said one or more criteria include a ranking of each of the limited number of CPU cores in terms of at least one of current workload, current demand and current utilization reported by a scheduler of the App or Internet web browser.
17. The method of any of clauses 12-16, wherein the step of disabling LPM in said at least one enabled CPU core comprises:
   comparing the total number of LPM entries and exits to a second TH value;
   selecting one or more enabled CPU cores for which LPM will be disabled based on the comparison of the total number of LPM entries and exits to the second TH value; and
   disabling LPM in the selected one or more enabled CPU cores.
18. The method of clause 17, wherein the second TH value is set based on an estimation for each CPU core of a respective power penalty associated with LPM entries and exits of the respective CPU core.
19. A non-transitory computer-readable medium comprising computer instructions for execution by logic disposed on an integrated circuit (IC) chip of a portable computing device (PCD) for reducing central processing unit (CPU) power costs in the PCD, the computer instructions comprising:
   a first set of instructions that determines if the PCD enters a static display read mode while running a mobile device software application program (App) or Internet web browser operating in reader mode, and if so:
   determining, with a second set of instructions, (1) if a display key performance indicator (KPI) headroom of the PCD indicates that one or more cost-saving actions can be performed without degrading visual performance of a display of the PCD and (2) if there is an active display buffer submission;
   if it is determined with the second set of instructions that display KPI headroom indicates that one or more cost-saving actions can be performed without degrading visual performance and that there is no active display buffer submission:
   analyzing, with a third set of instructions, hysteresis statistics associated with the CPU entering a low power mode (LPM) and exiting the LPM to calculate a total number of LPM entries and exits equal to a number of times the CPU enters the LPM during a preselected time window plus a number of times that CPU exits the LPM during the time window; and
   comparing, with a fourth set of instructions, the total number to a first preselected threshold (TH) value and performing one or more power cost-saving actions if the total number exceeds the first preselected TH value.
20. The non-transitory computer-readable medium of clause 19, wherein to perform said one or more power cost-saving actions, the fourth set of instructions comprises at least one of:
   a fifth set of instructions that limits a total number of cores of the CPU that are allowed to be utilized by the App or Internet web browser operating in reader mode to a limited number of CPU cores;
   a sixth set of instructions that enables one or more of the limited number of CPU cores; and
   a seventh set of instructions that disables LPM in at least one the enabled CPU cores.
21. The non-transitory computer-readable medium of clause 20, wherein the fifth set of instructions limits the total number of cores of the CPU that are allowed to be utilized by the App or Internet web browser operating in reader mode by:
   setting a minimum number of CPU cores that are needed by the App or Internet web browser to operate in static display read mode without degrading performance to a level that is visually perceivable by a user of the PCD; and
   setting a maximum number of CPU cores that may be needed by the App or Internet web browser to operate in static display read mode to ensure that performance will not degrade to a level that is visually perceivable by the user of the PCD.
22. The non-transitory computer-readable medium of any of clauses 20-21, wherein the sixth set of instructions enables one or more of the CPU cores by:
   of the limited number of CPU cores, selecting the minimum number of CPU cores to be enabled based on one or more criteria; and
   enabling the selected minimum number of CPU cores.
23. The non-transitory computer-readable medium of clause 22, wherein said one or more criteria include a ranking of each of the limited number of CPU cores in terms of power cost selecting the minimum number of CPU cores to be enabled based on the respective rankings.
24. The non-transitory computer-readable medium of clause 22, wherein said one or more criteria include a ranking of each of the limited number of CPU cores in terms of at least one of current workload, current demand and current utilization reported by a scheduler of the App or Internet web browser.
25. The non-transitory computer-readable medium of any of clauses 20-24, wherein the seventh set of instructions disables LPM in said at least one enabled CPU core by:
   comparing the total number of LPM entries and exits to a second TH value;
   selecting one or more enabled CPU cores for which LPM will be disabled based on the comparison of the total number of LPM entries and exits to the second TH value; and
   disabling LPM in the selected one or more enabled CPU cores.
26. The non-transitory computer-readable medium of clause 25, wherein the second TH value is set based on an estimation for each CPU core of a respective power penalty associated with LPM entries and exits of the respective CPU core.

It should be noted that the inventive principles and concepts have been described with reference to representative embodiments, but that the inventive principles and concepts are not limited to the representative embodiments described herein. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the appended claims.

What is claimed is:

1. A system for reducing central processing unit (CPU) power costs in a portable computing device (PCD), the system comprising:
logic disposed on an integrated circuit (IC) chip of the PCD, the logic being configured to:
determine if the PCD enters a static display read mode while running a mobile device software application program (App) or Internet web browser operating in reader mode, and if so:
determine (1) if a display key performance indicator (KPI) headroom of the PCD indicates that one or more cost-saving actions can be performed without degrading visual performance of a display of the PCD and (2) if there is an active display buffer submission;
if it is determined that display KPI headroom indicates that one or more cost-saving actions can be performed without degrading visual performance and that there is no active display buffer submission:
analyze hysteresis statistics associated with the CPU entering a low power mode (LPM) and exiting the LPM to calculate a total number of LPM entries and exits equal to a number of times the CPU enters the LPM during a preselected time window plus a number of times that CPU exits the LPM during the time window; and
compare the total number to a first preselected threshold (TH) value and perform one or more power cost-saving actions if the total number exceeds the first preselected TH value.

2. The system of claim 1, wherein performing said one or more power cost-saving actions comprises at least one of:
limiting a total number of cores of the CPU that are allowed to be utilized by the App or Internet web browser operating in reader mode to a limited number of CPU cores;
of the limited number of CPU cores, enabling one or more of the CPU cores such that the enabled one or more CPU cores are available to utilized by the App or Internet web browser operating in reader mode; and
limiting a total number of times at least one enabled CPU core is allowed to enter and exit LPM.

3. The system of claim 2, wherein the step of limiting the total number of times at least one enabled CPU core is allowed to enter and exit LPM is performed by disabling LPM in said at least one enabled CPU core.

4. The system of claim 3, wherein the step of limiting the total number of cores of the CPU that are allowed to be utilized by the App or Internet web browser operating in reader mode is performed by:
setting a minimum number of CPU cores that are needed by the App or Internet web browser to operate in static display read mode without degrading performance to a level that is visually perceivable by a user of the PCD; and
setting a maximum number of CPU cores that may be needed by the App or Internet web browser to operate in static display read mode to ensure that performance will not degrade to a level that is visually perceivable by the user of the PCD.

5. The system of claim 4, wherein the step of enabling one or more of the CPU cores is performed by:
of the limited number of CPU cores, selecting the minimum number of CPU cores to be enabled based on one or more criteria; and
enabling the selected minimum number of CPU cores.

6. The system of claim 5, wherein said one or more criteria include a ranking of each of the limited number of CPU cores in terms of power cost selecting the minimum number of CPU cores to be enabled based on the respective rankings.

7. The system of claim 5, wherein said one or more criteria include a ranking of each of the limited number of CPU cores in terms of at least one of current workload, current demand and current utilization reported by a scheduler of the App or Internet web browser.

8. The system of claim 4, wherein the step of disabling LPM in said at least one enabled CPU core comprises:
comparing the total number of LPM entries and exits to a second TH value;
selecting one or more enabled CPU cores for which LPM will be disabled based on the comparison of the total number of LPM entries and exits to the second TH value; and
disabling LPM in the selected one or more enabled CPU cores.

9. The system of claim 8, wherein the second TH value is set based on an estimation for each CPU core of a respective power penalty associated with LPM entries and exits of the respective CPU core.

10. A method for reducing central processing unit (CPU) power costs in a portable computing device (PCD), the method comprising, in logic disposed on an integrated circuit (IC) chip of the PCD:
determining if the PCD enters a static display read mode while running a mobile device software application program (App) or Internet web browser operating in reader mode, and if so:
determining (1) if a display key performance indicator (KPI) headroom of the PCD indicates that one or more cost-saving actions can be performed without degrading visual performance of a display of the PCD and (2) if there is an active display buffer submission;
if it is determined that display KPI headroom indicates that one or more cost-saving actions can be performed without degrading visual performance and that there is no active display buffer submission:
analyzing hysteresis statistics associated with the CPU entering a low power mode (LPM) and exiting the LPM to calculate a total number of LPM entries and exits equal to a number of times the CPU enters the LPM during a preselected time window plus a number of times that CPU exits the LPM during the time window; and
comparing the total number to a first preselected threshold (TH) value and performing one or more power cost-saving actions if the total number exceeds the first preselected TH value.

11. The method of claim 10, wherein performing said one or more power cost-saving actions comprises at least one of:
limiting a total number of cores of the CPU that are allowed to be utilized by the App or Internet web browser operating in reader mode to a limited number of CPU cores;
of the limited number of CPU cores, enabling one or more of the CPU cores such that the enabled one or more CPU cores are available to utilized by the App or Internet web browser operating in reader mode; and
limiting a total number of times at least one enabled CPU core is allowed to enter and exit LPM.

12. The method of claim 11, wherein the step of limiting the total number of times at least one enabled CPU core is allowed to enter and exit LPM comprises:
disabling LPM in said at least one enabled CPU core.

13. The method of claim 12, wherein the step of limiting the total number of cores of the CPU that are allowed to be utilized by the App or Internet web browser operating in reader mode comprises:
setting a minimum number of CPU cores that are needed by the App or Internet web browser to operate in static display read mode without degrading performance to a level that is visually perceivable by a user of the PCD; and
setting a maximum number of CPU cores that may be needed by the App or Internet web browser to operate in static display read mode to ensure that performance will not degrade to a level that is visually perceivable by the user of the PCD.

14. The method of claim 13, wherein the step of enabling one or more of the CPU cores comprises:
of the limited number of CPU cores, selecting the minimum number of CPU cores to be enabled based on one or more criteria; and
enabling the selected minimum number of CPU cores.

15. The method of claim 14, wherein said one or more criteria include a ranking of each of the limited number of CPU cores in terms of power cost selecting the minimum number of CPU cores to be enabled based on the respective rankings.

16. The method of claim 14, wherein said one or more criteria include a ranking of each of the limited number of CPU cores in terms of at least one of current workload, current demand and current utilization reported by a scheduler of the App or Internet web browser.

17. The method of claim 13, wherein the step of disabling LPM in said at least one enabled CPU core comprises:
comparing the total number of LPM entries and exits to a second TH value;
selecting one or more enabled CPU cores for which LPM will be disabled based on the comparison of the total number of LPM entries and exits to the second TH value; and
disabling LPM in the selected one or more enabled CPU cores.

18. The method of claim 17, wherein the second TH value is set based on an estimation for each CPU core of a respective power penalty associated with LPM entries and exits of the respective CPU core.

19. A non-transitory computer-readable medium comprising computer instructions for execution by logic disposed on an integrated circuit (IC) chip of a portable computing device (PCD) for reducing central processing unit (CPU) power costs in the PCD, the computer instructions comprising:
a first set of instructions that determines if the PCD enters a static display read mode while running a mobile device software application program (App) or Internet web browser operating in reader mode, and if so:
determining, with a second set of instructions, (1) if a display key performance indicator (KPI) headroom of the PCD indicates that one or more cost-saving actions can be performed without degrading visual performance of a display of the PCD and (2) if there is an active display buffer submission;
if it is determined with the second set of instructions that display KPI headroom indicates that one or more cost-saving actions can be performed without degrading visual performance and that there is no active display buffer submission:
analyzing, with a third set of instructions, hysteresis statistics associated with the CPU entering a low power mode (LPM) and exiting the LPM to calculate a total number of LPM entries and exits equal to a number of times the CPU enters the LPM during a preselected time window plus a number of times that CPU exits the LPM during the time window; and
comparing, with a fourth set of instructions, the total number to a first preselected threshold (TH) value and performing one or more power cost-saving actions if the total number exceeds the first preselected TH value.

20. The non-transitory computer-readable medium of claim 19, wherein to perform said one or more power cost-saving actions, the fourth set of instructions comprises at least one of:
a fifth set of instructions that limits a total number of cores of the CPU that are allowed to be utilized by the App or Internet web browser operating in reader mode to a limited number of CPU cores;
a sixth set of instructions that enables one or more of the limited number of CPU cores; and
a seventh set of instructions that disables LPM in at least one the enabled CPU cores.

21. The non-transitory computer-readable medium of claim 20, wherein the fifth set of instructions limits the total number of cores of the CPU that are allowed to be utilized by the App or Internet web browser operating in reader mode by:
setting a minimum number of CPU cores that are needed by the App or Internet web browser to operate in static display read mode without degrading performance to a level that is visually perceivable by a user of the PCD; and
setting a maximum number of CPU cores that may be needed by the App or Internet web browser to operate in static display read mode to ensure that performance will not degrade to a level that is visually perceivable by the user of the PCD.

22. The non-transitory computer-readable medium of claim 21, wherein the sixth set of instructions enables one or more of the CPU cores by:
of the limited number of CPU cores, selecting the minimum number of CPU cores to be enabled based on one or more criteria; and
enabling the selected minimum number of CPU cores.

23. The non-transitory computer-readable medium of claim 22, wherein said one or more criteria include a ranking of each of the limited number of CPU cores in terms of power cost selecting the minimum number of CPU cores to be enabled based on the respective rankings.

24. The non-transitory computer-readable medium of claim 22, wherein said one or more criteria include a ranking of each of the limited number of CPU cores in terms of at least one of current workload, current demand and current utilization reported by a scheduler of the App or Internet web browser.

25. The non-transitory computer-readable medium of claim 22, wherein the seventh set of instructions disables LPM in said at least one enabled CPU core by:
comparing the total number of LPM entries and exits to a second TH value;
selecting one or more enabled CPU cores for which LPM will be disabled based on the comparison of the total number of LPM entries and exits to the second TH value; and
disabling LPM in the selected one or more enabled CPU cores.

26. The non-transitory computer-readable medium of claim 25, wherein the second TH value is set based on an estimation for each CPU core of a respective power penalty associated with LPM entries and exits of the respective CPU core.
